(19) United States
(12) Patent Application Publication
(10) Pub. No.: US 2005/0150317 A1
(43) Pub. Date: Jul. 14, 2005

(54) Worm-screw adjustment device, a runner including such an adjustment device, and a seat including such a runner

(76) Inventors: Sylvain Desquesne, Conde Sur Noireau (FR); Dominique Folliot, Flers (FR)

Correspondence Address: MCCRACKEN & FRANK LLP, 200 W. ADAMS STREET, SUITE 2150, CHICAGO, IL, 60606, US

(21) Appl. No.: 10/954,327

(22) Filed: Sep. 30, 2004

(30) Foreign Application Priority Data
Oct. 2, 2003 (FR) FR03 11561

(51) Int. Cl. F16H 1/26

(52) U.S. Cl. 74/89.36

(57) ABSTRACT

An adjustment device comprises a nut floatingly mounted on a rigid base, and a worm screw screwed through the nut. The worm screw is mounted to rotate substantially without radial clearance in a bearing that is secured to the base.

The present invention relates to worm-screw adjustment devices, to runners including such adjustment devices, and to seats including such runners.

More particularly, the invention relates to an adjustment device for mounting in particular in a vehicle (and by way of non-exclusive example, in a runner for adjusting the longitudinal position of a seat), the device comprising a nut floatingly mounted on a rigid base and a worm screw screwed in the nut.

### BACKGROUND OF THE INVENTION

Document FR-A-2 796 013 describes such an adjustment device.

### OBJECTS AND SUMMARY OF THE INVENTION

Known devices of that type give satisfaction. Nevertheless, it appears useful to improve them further, in particular to limit the noise they can generate, particularly when in operation.

For this purpose, according to the invention, an adjustment device of the kind in question comprises a worm screw mounted to rotate substantially without radial clearance in a bearing secured to the base.

In addition, because the screw is guided better than in the prior art, it is possible, where appropriate, to mount the worm screw in a manner that is simpler than in the prior art. In particular, when the adjustment device is used for adjusting the relative position of first and second elements which are connected respectively to the base and to the worm screw, said worm screw may optionally be connected to the second element via one end only of the worm screw.

In various embodiments of the invention, recourse may optionally also be had to one or more of the following dispositions:
the bearing comprises a ring which is secured to the base and which surrounds the worm screw with a certain amount of radial clearance, the ring being extended away from the nut by a plurality of resilient tabs which press radially inwards against the worm screw;
each resilient tab is substantially in the form of a portion of a cylinder with its concave sides facing towards the worm screw;
the base presents a bottom which extends parallel to the worm screw between first and second end walls each having the worm screw passing therethrough with clearance, the nut being received between said first and second end walls, and said ring being engaged without clearance in the first end wall;
the bearing includes at least one bearing portion which extends said ring radially outwards and which is interposed axially between the first end wall and the nut;
the bearing portion is extended parallel to the worm screw by two parallel retention flanges disposed on either side of the nut and adapted to limit any turning movement of the nut about the worm screw;
the bearing portion is extended parallel to the worm screw by two parallel holding flanges which are engaged on either side of the first end wall of the base and which are adapted to prevent the bearing from turning relative to the base about the worm screw;
the bearing is made as a single piece of plastics material; and
at least one layer of elastomer is interposed between the nut and the base.

The invention also provides a runner comprising first and second bars mounted to slide relative to each other, and an adjustment device as defined above, the base being secured to the first bar and the worm screw being connected to the second bar.

Advantageously, in an embodiment, the worm screw extends longitudinally between two ends and is connected to the second bar via only one of its ends.

Finally, the invention also provides a vehicle seat carried by at least one runner as defined above.

### BRIEF DESCRIPTION OF THE DRAWINGS

Other characteristics and advantages of the invention will appear on reading the following description of an embodiment, given by way of non-limiting example and with reference to the accompanying drawings.

In the drawings:

FIG. 1 is a diagrammatic view showing a seat fitted with runners for longitudinal adjustment constituting an embodiment of the invention;

FIG. 2 is a plan view of the two longitudinal adjustment runners of the FIG. 1 seat;

FIG. 3 is a vertical longitudinal section view of one of the two FIG. 2 runners;

FIG. 4 is a detail view showing a portion of the adjustment device of the FIG. 3 runner;

FIG. 5 is a section view on line V-V of FIG. 4;

FIG. 6 is a perspective view of the portion of the adjustment device that is visible in FIGS. 4 and 5; and

FIG. 7 is a perspective view of the bearing surrounding the worm screw of the adjustment device visible in FIGS. 4 and 5.

### MORE DETAILED DESCRIPTION

In the various figures, the same references designate elements that are identical or similar.

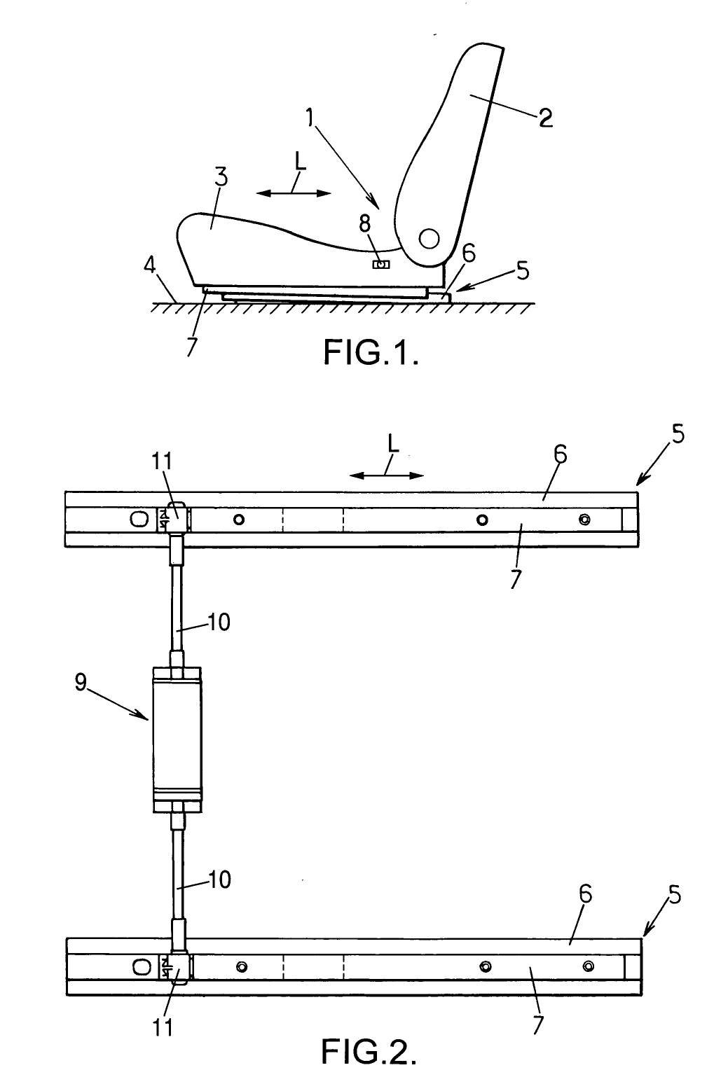

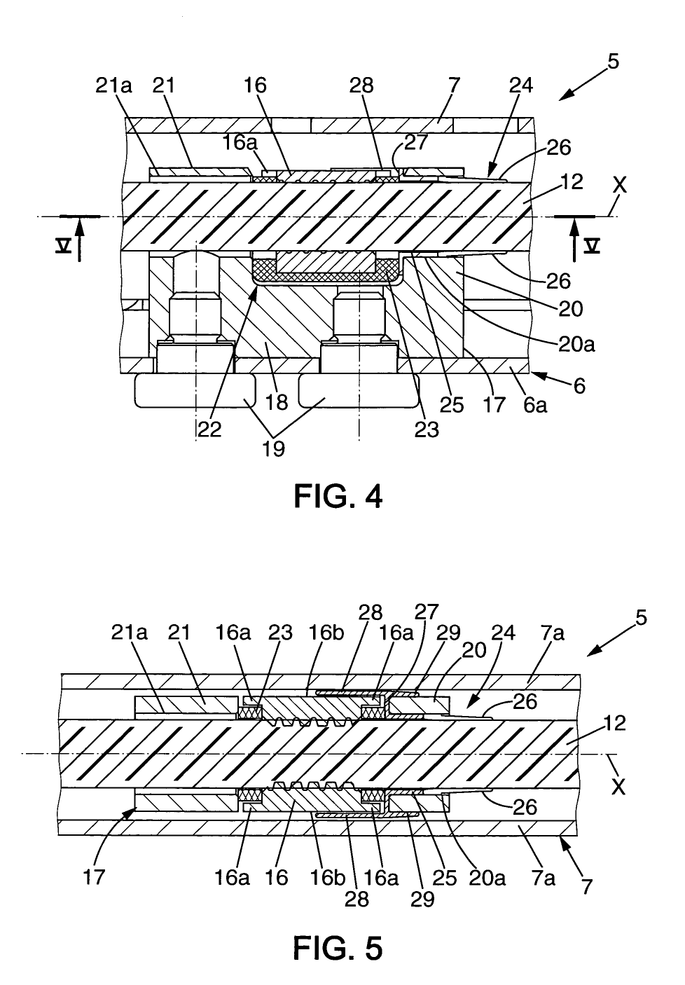

FIG. 1 shows a motor vehicle seat 1 comprising a seat back 2 and a seat proper 3 mounted on the floor 4 of the vehicle via two parallel runners 5. Each of the two runners 5, only one of which is visible in FIG. 4, comprises first and second bars 6, 7 mounted to slide relative to each other, one being secured to the floor 4 and the other to the seat proper 3 so as to enable the seat to slide forwards or rearwards in a longitudinal direction L.

Mutual sliding between the bars 6 and 7 in the two runners 5 can be driven by means of an electric motor, for example, under the control of a pushbutton 8, for example.

As shown in FIG. 2, the electric motor 9 may be located beneath the seat proper 3 and may be connected, via two rigid or flexible shafts 10, to two transmission mechanisms 11 such as, in particular, step-down gearboxes with angle takeoffs, each mechanism being fixed to the second bar 7 of one of the runners 5.

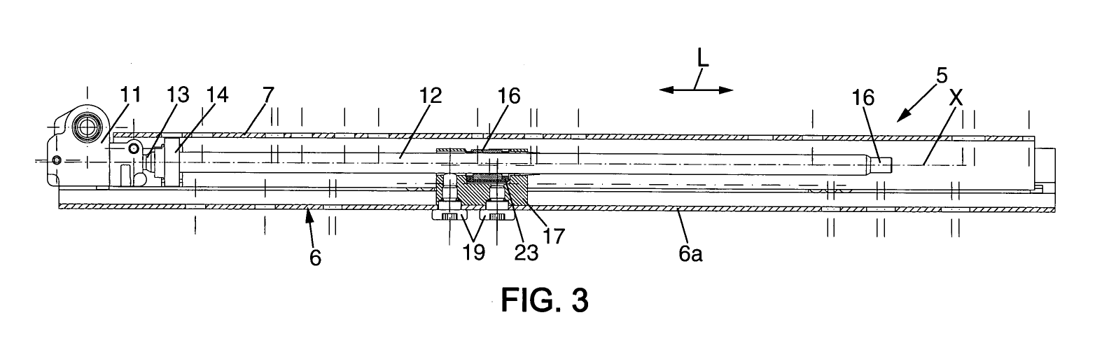

As shown in FIG. 3, the transmission mechanism 11 rotates a worm screw 12 which extends along a central axis X parallel to the longitudinal direction L inside the corresponding runner 5. This worm screw 12 extends between:
firstly a first end 13 driven by the transmission mechanism 11 and mounted to rotate in a bearing 14 that is secured to the second bar 7; and
secondly a second end 15 which is preferably left free. The worm screw 12 is thus preferably connected to the second bar 7 via its first end 13, only.

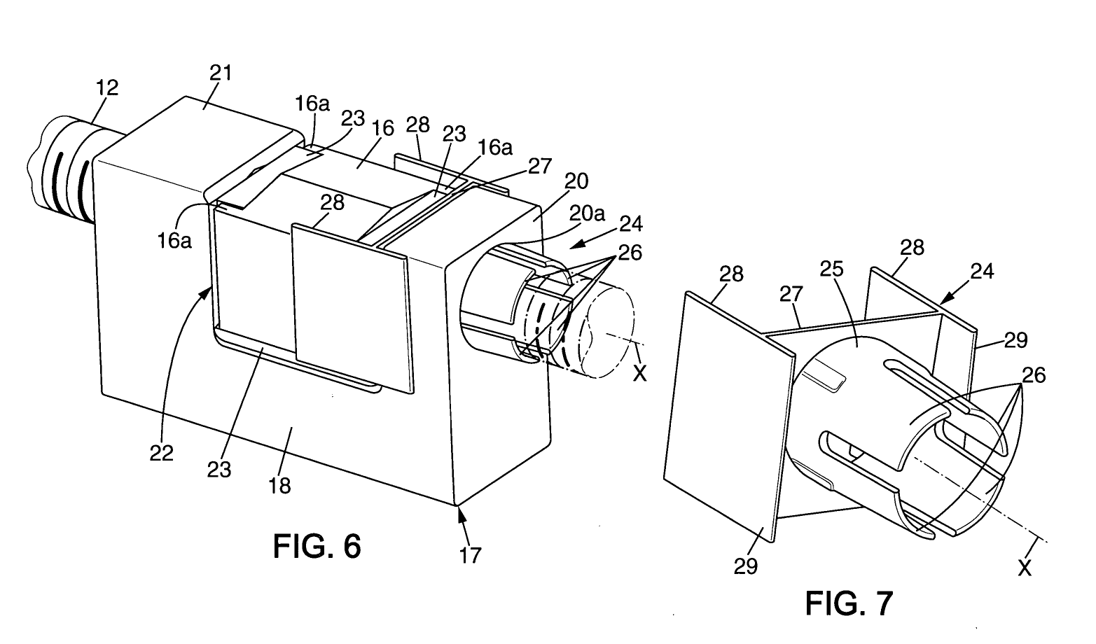

In addition, and as shown in greater detail in FIGS. 4 to 7, the adjustment device for each runner 5 also comprises a nut 16 floatingly mounted on a rigid base 17 which is itself secured to the first bar 6 of the corresponding runner 5, the worm screw 12 being in screw engagement through the nut 16.

More particularly, in the example described herein, the base 17 may be substantially U-shaped, having a bottom 18, e.g. secured to the bottom 6a of the first part 6, by means of screws 19 for example, or in some other way. The bottom 18 extends in the longitudinal direction L between first and second end walls 20 and 21 presenting respective openings 20a and 21a, each passing the worm screw 12 with radial clearance. The bottom 18 thus co-operates with the two end walls 20 and 21 to define a notch 22 in which the nut 16 is received with clearance.

An elastomer layer 23 is preferably interposed between the nut 16 and the base 17. More particularly, this elastomer layer 23 may be U-shaped so as to match the internal periphery of the notch 22 and be interposed firstly vertically between the nut 16 and the bottom.18, and secondly axially between the nut 16 and each of the end walls 20 and 21. Advantageously, the nut 16 may further include abutment walls 16a disposed on either side of the elastomer layer 23 and projecting parallel to the axis X towards the first and second end walls 20 and 21. These abutment walls 16a are not normally in contact with the end walls 20 and 21, but they can come into contact with one or other of said end walls so as to limit flattening of the elastomer layer 23 when the nut 16 is subjected to an exceptional axial force.

According to the invention, the worm screw 12 is mounted to rotate substantially without radial clearance in a bearing 24 that is secured to the base 17.

More particularly, in the example described herein, the bearing 24 in question can advantageously comprise a circular ring 25 which is engaged tightly in the opening 20a in the first end wall, said ring surrounding the worm screw 12 with a small amount of radial clearance (see FIGS. 4 and 5), with said ring extending axially away from the nut 16 in the form of two resilient tabs 26 which bear resiliently against the worm screw 12 in a radial direction.

Advantageously, the resilient tabs are substantially in the form of portions of a cylinder of diameter that is slightly smaller than that of the ring 25, with their concave sides facing towards the worm screw, so as to fit snugly against the cylindrical outer envelope of said worm screw. There are four of these resilient tabs in the example described, however the number of tabs could be different.

At its axial end remote from the tabs 26, the ring 25 is also extended radially outwardly by a bearing portion 27 which is interposed axially between the nut 16 and the first end wall 20.

This axial bearing portion 27 in the example shown is in the form of a rectangular wall which extends transversely in the horizontal direction between two ends which are extended:
firstly by two retention flanges 28 that are vertical and parallel, on either side of the nut 16; and
secondly by two holding flanges 29 that are vertical and parallel and which extend in the opposite direction to the flanges 28 on either side of the first end wall 20.

The axial bearing portion 27 serves to prevent the bearing 24 from moving axially, while the holding flanges 29 press against opposite sides of the first end wall 20 so as to prevent the bearing 24 from turning about the axis X relative to the base 17.

In addition, the retaining flanges 28 bear against two plane faces 16b of the nut 16 (see FIG. 5) so as to limit turning movements of the nut 16 about the axis X, thereby serving in particular to prevent the nut 16 from coming into abutment against the side walls 7a of the second bar 7.

Advantageously, the entire bearing 24 can be molded as a single piece of plastics material, e.g. of VI-VI polyamide filled with fiberglass, or some other material.

Because of the presence of the bearing 24, the worm screw 12 is accurately guided and does not run any risk of coming into abutment against the end walls 20 and 21 of the base. This thus enables the runners 5 to operate in particularly silent manner.

In addition, because of the worm screw 12 is excellently guided by the bearing 24, the second end 15 of the worm screw can optionally be left free (see FIG. 3), thus avoiding any need to mount it on a bearing that is secured to the second bar 7, as is done in the prior art. This makes the runner considerably simpler to assemble (in the past it has been necessary to mount the second end 15 in a bearing secured to the second bar 7 while acting blind, which is particularly difficult). In addition, the worm screw 12 can thus be mounted in isostatic manner, thereby contributing to simplifying its mounting and to making it more reliable.

1. An adjustment device comprising a nut floatingly mounted on a rigid base and a worm screw screwed in the nut,
wherein the worm screw is rotatably mounted substantially without radial clearance in a bearing that is secured to the base.

2. An adjustment device according to claim 1, in which the bearing comprises a ring which is secured to the base and which surrounds the worm screw with a certain amount of radial clearance, the ring being extended away from the nut by a plurality of resilient tabs which press radially inwards against the worm screw.

3. An adjustment device according to claim 2, in which each resilient tab is substantially in the form of a portion of a cylinder with its concave sides facing towards the worm screw.

4. An adjustment device according to claim 2, in which the base presents a bottom which extends parallel to the worm screw between first and second end walls each having the worm screw passing therethrough with clearance, the nut being received between said first and second end walls, and said ring being engaged without clearance in the first end wall.

5. An adjustment device according to claim 2, in which the bearing includes at least one bearing portion which extends said ring radially outwards and which is interposed axially between the first end wall and the nut.

6. An adjustment device according to claim 5, in which the bearing portion is extended parallel to the worm screw by two parallel retention flanges disposed on either side of the nut and adapted to limit any turning movement of the nut about the worm screw.

7. An adjustment device according to claim 5, in which the bearing portion is extended parallel to the worm screw by two parallel holding flanges which are engaged on either side of the first end wall of the base and which are adapted to prevent the bearing from turning relative to the base about the worm screw.

8. An adjustment device according to claim 1, in which the bearing is made as a single piece of plastics material.

9. An adjustment device according to claim 1, in which at least one layer of elastomer is interposed between the nut and the base.

10. A runner comprising first and second bars mounted to slide relative to each other, and an adjustment device according to claim 1, the base being secured to the first bar and the worm screw being connected to the second bar.

11. A runner according to claim 10, in which the worm screw extends longitudinally between two ends and is connected to the second bar via only one of its ends.

12. A vehicle seat carried by at least one runner according to claim 10.
